(19) United States
(12) Patent Application Publication
(10) Pub. No.: US 2025/0076686 A1
(43) Pub. Date: Mar. 6, 2025

(54) DISPLAY DEVICE

(71) Applicant: Shenzhen Arcension Technology Co., Ltd, Shenzhen (CN)

(72) Inventors: Yingnan ZHAI, Shenzhen (CN); Jieyang JIA, Shenzhen (CN); Xudong DENG, Shenzhen (CN)

(21) Appl. No.: 18/432,974

(22) Filed: Feb. 5, 2024

(30) Foreign Application Priority Data
Sep. 6, 2023 (CN) 202311148494.3

(51) Int. Cl. G02C 11/00

(52) U.S. Cl. CPC G02C 11/10

(57) ABSTRACT

A display device includes: a mounting base; an optical engine mounted on the mounting base; a first connecting portion arranged on the mounting base and configured to be connected to a first side of the lens; and a second connecting portion arranged opposite to the first connecting portion and configured to be connected to a second side of the lens, the first side and the second side of the lens being opposing sides. The first connecting portion and the second connecting portion are configured to clamp the lens and allow the mounting base to move on the lens, to adjust a position of the optical engine relative to the lens.

### CROSS-REFERENCE TO RELATED APPLICATIONS

This application claims priority to China Patent Application No. 2023111484943, filed on Sep. 6, 2023, the content of which is hereby incorporated by reference in its entirety.

### TECHNICAL FIELD

The present disclosure relates to the field of enhanced display technology, and in particular, to a display device.

### BACKGROUND

Augmented Reality (AR) technology is a technology that cleverly integrates virtual information with the real world, and widely adopts technical means such as multimedia, three-dimensional modeling, real-time tracking and registration, intelligent interaction, sensing, and the like, to simulate and apply virtual information such as text, images, three-dimensional models, music, videos etc., generated by a computer, to the real world. In this way, two types of information complement each other, thereby achieving “enhancement” of the real world.

In conventional head-mounted devices, general microdisplays (such as optical engines) are arranged in front of the human eye, and mostly, can be realized using optical waveguide technology. In addition, the optical engines or optical modules are always in a fixed position, but in fact, different people have different head shapes, and thus different people have different interpupillary distances and field of view (FOV), or some acquired factors cause the field of view of glasses to be different. Such differences can easily lead to different people perceiving different display positions of the head-mounted optical engine, which can easily lead to different effects on the content range or clarity seen by different users. In addition, different users also have different viewing needs and preferences for different viewing angles.

### SUMMARY

Embodiments of the present disclosure provide a display device.

In a first aspect, an embodiment of the present disclosure provides a display device, which includes:
a mounting base;
an optical engine mounted on the mounting base;
a first connecting portion arranged on the mounting base and configured to be connected to a first side of the lens; and
a second connecting portion arranged opposite to the first connecting portion and configured to be connected to a second side of the lens, the first side and the second side of the lens being opposing sides;

The first connecting portion and the second connecting portion are configured to clamp the optical lens and allow the mounting base to move on the optical lens, so as to adjust a position of the optical engine relative to the lens.

In a first aspect, an embodiment of the present disclosure provides a wearable device, which includes: a lens; a frame on which the lens is arranged; and the display device as described above. The display device is arranged on the lens.

### BRIEF DESCRIPTION OF THE DRAWINGS

In order to illustrate the technical solutions more clearly in the embodiments of the present disclosure, the drawings needed to be used in the description of the embodiments will be briefly introduced below. Apparently, the drawings in the following description only illustrate some embodiments of the present disclosure. For those skilled in the art, other drawings can also be obtained based on these drawings without exerting creative efforts.

FIG. 1 is a perspective view showing an application scenario of a display device according to an embodiment of the present disclosure.

FIG. 2 is a perspective view of a display device according to an embodiment of the present disclosure.

FIG. 3 is an exploded view of the display device of FIG. 2.

FIG. 4 is an exploded view of a mounting base of FIG. 2.

FIG. 5 is an exploded view of a display device according to another embodiment of the present disclosure.

FIG. 6 is a perspective view of a display device according to another embodiment of the present disclosure.

FIG. 7 is an exploded view of the display device of FIG. 6.

FIG. 8 is a perspective view showing another application scenario of a display device according to another embodiment of the present disclosure.

FIG. 9 is an exploded view of the display device of FIG. 8.

FIG. 10 is a further exploded view of the display device of FIG. 8.

FIG. 11 is a further exploded view of the display device of FIG. 8.

FIG. 12 is a further exploded view of the display device of FIG. 8.

### DETAILED DESCRIPTION OF THE EMBODIMENTS

The technical solutions in the embodiments of the present disclosure will be clearly and completely described below with reference to the accompanying drawings in the embodiments of the present disclosure. Apparently, the described embodiments only illustrate some of the embodiments of the present disclosure, rather than all the embodiments. Based on the embodiments of the present disclosure, all other embodiments obtained by those skilled in the art without making creative efforts fall within the scope of protection of the present disclosure.

In the description of the present disclosure, it should be understood that orientations or positional relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, etc. are based on the orientations or positional relationships shown in the accompanying drawings, which are only for the convenience of describing the present disclosure and simplifying the description, but do not indicate or imply that the device or element referred to must have a specific orientation, be constructed and operated in a specific orientation, and therefore cannot be understood as a limitation of the present disclosure. In addition, the terms “first” and “second” are used for descriptive purposes only and cannot be understood as indicating or implying relative importance or implicitly indicating the quantity of indicated technical features. Therefore, the features defined by “first” and “second” may explicitly or implicitly include one or more features. In the description of the present disclosure, “plurality” means two or more than two, unless otherwise explicitly and specifically defined.

In the present disclosure, the word “exemplary” is used to express “serving as an example, illustration or explanation”. Any embodiment described as “exemplary” in the disclosure is not necessarily to be construed as preferred or advantageous over other embodiments. The following description is presented to enable any person skilled in the art to enable and use the disclosure. In the following description, details are set forth for the purpose of illustration. It is to be understood that, as appreciated by one of ordinary skill in the art that the present disclosure may be practiced without these specific details. In other instances, well-known structures and processes have not been described in detail to avoid obscuring the description of the disclosure by unnecessary detail. Thus, the present disclosure is not intended to be limited to the embodiments shown but is to be consistent with the widest scope accorded the disclosed principles and features of this disclosure.

Embodiments of the present disclosure provide display devices, which are each illustrated in detail below, to address at least the problems in the prior art that difficulty in seeing the contents of head-mounted devices or discomfort in wearing the head-mounted devices cause by differences in eye positions and field of view angles of different users, or inability to meet viewing needs and preferences of different users, etc.

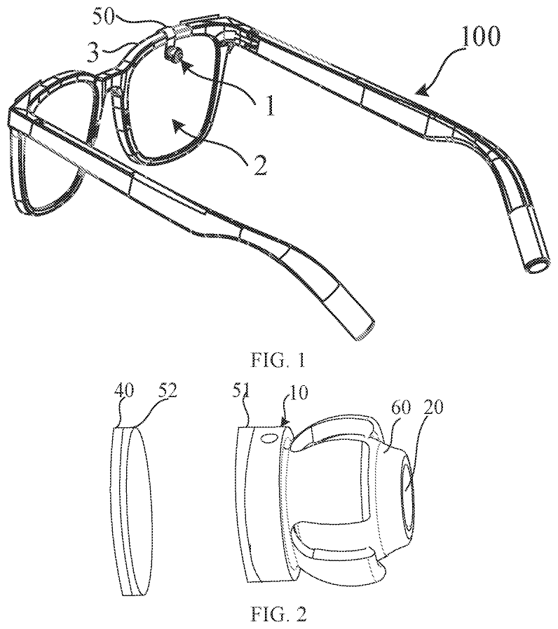

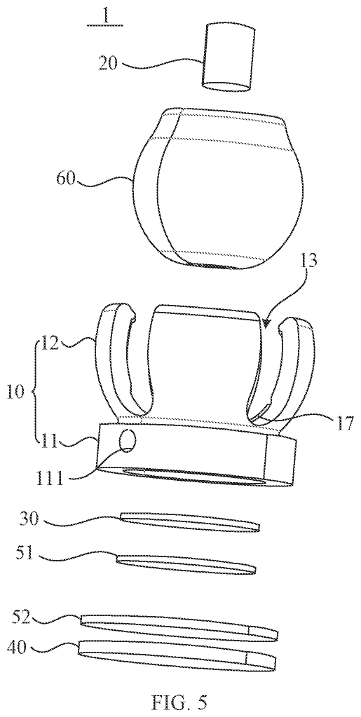

Referring to FIGS. 1 to 5, the present disclosure provides a display device 1, which is applied to an optical lens 2. The lens 2 can be goggles, smart glasses, myopia glasses, hyperopia glasses, sports glasses, or other near-eye or head-mounted optical lenses, etc. The lens 2 can face the user's eyes. The display device 1 includes a mounting base 10, an optical engine 20, a first connecting portion 30, and a second connecting portion 40.

The optical engine 20 is mounted on the mounting base 10. The mounting base 10 can be made of plastic or metal. The mounting base 10 can be provided with a mounting groove. The optical engine 20 is located in the mounting groove. The optical engine 20 can include a microdisplay, such as a micro light-emitting diode (Micro-LED), a micro-light-emitting diode (uLED), micro organic light-emitting diode (Micro-oled), liquid crystal on silicon (LCoS), liquid crystal display (LCD), digital micromirror device (DMD)/digital light processing (DLP) or laser beam scanning (LBS), or any combination thereof. It can be understood that the optical engine 20 may further include a micro-optical module, etc. The micro-optical module is arranged in front of a micro-display. The light from the micro-display is emitted out after passing through the micro-optical module.

The first connecting portion 30 is arranged on the mounting base 10 and is configured to be connected to a first side of the lens 2. The second connecting portion 40 is arranged opposite to the first connecting portion 30 and is configured to be connected to a second side of the lens 2. The first side and the second side of the lens 2 are opposing sides. It should be understood that, the first side may be a side of the lens 2 facing the human eye, the second side may be a side of the lens 2 away from the human eye. The first connecting portion 30 and the second connecting portion 40 are configured to clamp the lens 2 and allow the mounting base 10 to move on the lens 2, so as to adjust a position of the optical engine 20 relative to the lens 2. It should be understood that, for example, when the optical engine 20 has at least a first position and a second position that is different from the first position, the optical engine 20 can freely move between the first position and the second position. The specific movement can also be a movement relative to the periphery of the lens 2 at a certain distance, or can be a movement relative to the any position of the lens 2, as long as it can meet that the portion where the optical engine 20 emits the light can be adjusted and moved within the visual range of the human eye. By adjusting the position of the optical engine 20 in the field of view of the human eye,

the position of the optical engine 20 can be accurately adjusted to realize the vision effect from the light of the optical engine 20 to the human eye, thereby meeting different people with different interpupillary distances or field of view angles, and meeting the viewing needs and preferences of different users. On the other hand, it can also provide flexible position testing in the early stage of research and development, to achieve the expected design effect.

The first connecting portion 30 and the second connecting portion 40 can be understood as components connected to each other. For example, the first connecting portion 30 and the second connecting portion 40 may be plates connected to each other. For example, the first connecting portion 30 may be a part of the mounting base 10, or may be an independent component, which is fixed on the mounting base 10 by bonding, engaging or threaded connection. The second connecting portion 40 can be a relatively independent component. For example, the second connecting portion 40 can be a component that cooperates with the first connecting portion 30 to achieve clamping effect or attraction effect. For example, the first connecting portion 30 and the second connecting portion 40 may be clamping plates to achieve clamping effect, or may achieve clamping effect by magnetic attraction, or a combination of the above may be adopted, and so on.

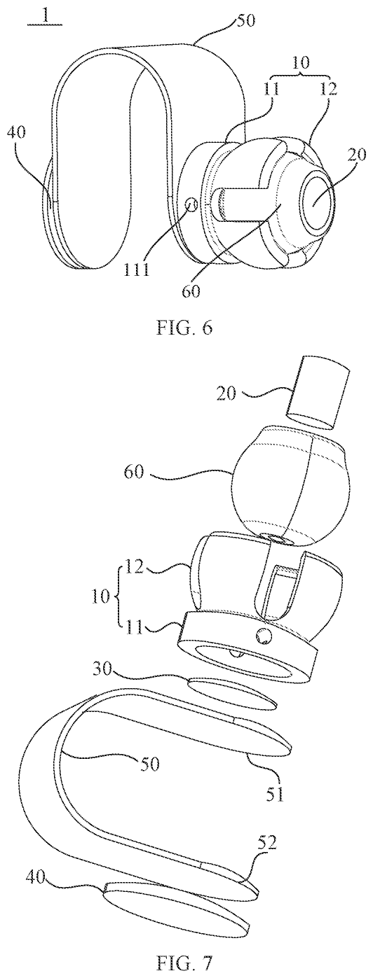

In some embodiments, referring to FIGS. 2 to 6, the display device 1 may further include a first protective layer 51 and a second protective layer 52. The first protective layer 51 is connected to the first connecting portion 30 and faces the second connecting portion 40. The second protective layer 52 is connected to the second connecting portion 40 and faces the first connecting portion 30. The first protective layer 51 and the second protective layer 52 are configured to in contact with the lens 2 and prevent the lens 2 from being damaged when the first connecting portion 30 and the second connecting portion 40 move relative to the lens 2. In practical applications, since most of the lenses 2 are precision components, which are made of resin or glass for example, if the optical engine 20 moves with the first connecting portion 30 and the second connecting portion 40 for too many times, the lens 2 may be easily worn. Therefore, the protective layers 51, 52 can play a buffering and protective role, to prevent the first connecting portion 30 and the second connecting portion 40 made of too rigid materials from directly damaging the lens 2. The first protective layer 51 and the second protective layer 52 can be made of relatively soft material, such as polyvinyl chloride (PVC), sponge, rubber, plastic, etc. In addition, the first protective layer 51 and the second protective layer 52 can also be made of thinner materials, for example, may be a plating, coating, etc., arranged on a connecting portion of a contact surface of the corresponding lens 2. The first protective layer 51 and the second protective layer 52 may be configured as needed, as long as they can be in contact with the lens 2 and is not likely to cause damage to the lens 2 during movement, thereby achieving a certain degree of protection. In other embodiments, protective layers can also be arranged on both sides of the first connecting portion 30 or the second connecting portion 40 to ensure the entire integrity.

In some embodiments, the first connecting portion 30 and the second connecting portion 40 may be made of magnetic materials that are attracted to each other. The first connecting portion 30 and the second connecting portion 40 may be magnets. Alternatively, the first connecting portion 30 may be a metal such as iron, cobalt, nickel, and alloys thereof, and the second connecting portion 40 is a magnet. In other embodiments, the second connecting portion 40 may be a metal such as iron, cobalt, nickel, and alloys thereof, and the first connecting portion 30 is a magnet. The first connecting portion 30 and the second connecting portion 40 can be configured as needed, as long as the clamping effect or the like can be achieved.

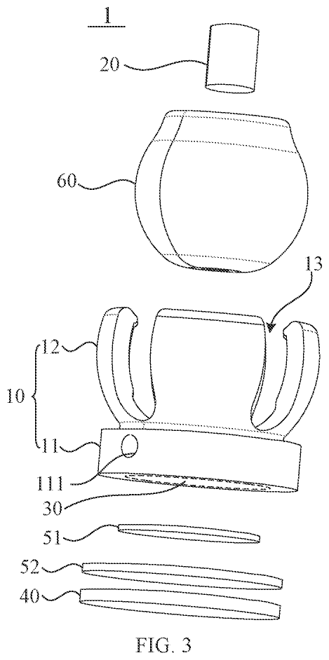

In some embodiments, referring to FIG. 3 or FIG. 10, the first connecting portion 30 is integrally formed with the mounting base 10. For example, the first connecting portion 30 may be the bottom (as shown in FIG. 3) or the top (as shown in FIG. 10) of the mounting base 10. That is, a corresponding portion of the first connecting portion 30 facing the second connecting portion 40 can cooperate with the second connecting portion 40 to achieve the clamping effect. For example, the mounting base 10 may be made of metal, and the second connecting portion 40 may be a magnet.

In some embodiments, referring to FIGS. 1 and 7, the display device 1 may further include a connecting member 50. One end of the connecting member 50 is connected to the first connecting portion 30 and/or the first protective layer 51, and the other end of the connecting member 50 is connected to the second connecting portion 40 and/or the second protective layer 52. The connecting member 50 is configured to span the lens 2. For example, the connecting member 50 may be U-shaped. It can be understood that the two ends of the connecting member 50 can be directly connected (for example, bonded, etc.) to the first connecting portion 30 and the second connecting portion 40. Since the protective layers 51, 52 are directly connected to the connecting portions 30, 40, the connecting member 50 can also be connected to the first protective layer 50 or the second protective layer 52. Optionally, the connecting member 50 may also be wrapped around the first connecting portion 30 or the second connecting portion 40. The arrangement of the connecting member 50 can reduce the probability of component loss. It can be understood that the display device 1 of the present disclosure is smaller than the human eye, and the maximum diameter of a single first or second connecting portion 30, 40 is less than or equal to 5 mm, therefore, connecting the first connecting portion 30 to the second connecting portion 40 can ensure that the first connecting portion 30 and the second connecting portion 40 is connected to the lens 2 or a frame 3 connected to the lens 2 as a whole. When falling, the whole structure formed by connecting the first connecting portion 30 to the second connecting portion 40 is relatively large, and is thus easily to be found or picked up. Optionally, referring to FIG. 7, the connecting member 50 and the protective layers 51, 52 can also be integrally formed, and made of the same material. For example, the first protective layer 51, the second protective layer 52, and the connecting member 50 can be integrally formed. In this case, the connecting member 50 can play the role of both connection and protection.

Optionally, the first connecting portion 30 and the second connecting portion 40 are made of non-magnetic material, and the connecting member 50 can also play a role of adjusting the moving distance. The moving distances of the first connecting portion 30 and the second connecting portion 40 on the lens 2 can be within approximately half the length of the connecting member 50, for example, within the lateral range of approximately half the length of the connecting member 50 from the frame 3 of the lens 2, etc.

In other embodiments, the connecting member 50 may be a torsion spring, memory metal, plastic, rope, etc. For example, the first connecting portion 30 and the second connecting portion 40 are clamping plates cooperating with each other, and the connecting member 50 is a torsion spring. In other embodiments, if the first connecting portion 30 and the second connecting portion 40 are made of magnetic materials that are attracted to each other, the connecting portion may be omitted. In order to reduce the probability of the loss of the magnet due to its too small volume, any feasible connecting member 50 may be used. In other embodiments, the connecting member 50 can be replaced, for example, to adapt to the positional movement of different lenses 2. Optionally, the connecting member 50 can also be telescopic or elastic, such that the overall length of the connecting member 50 can be adjusted.

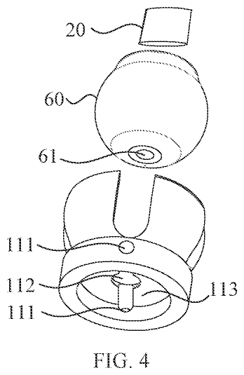

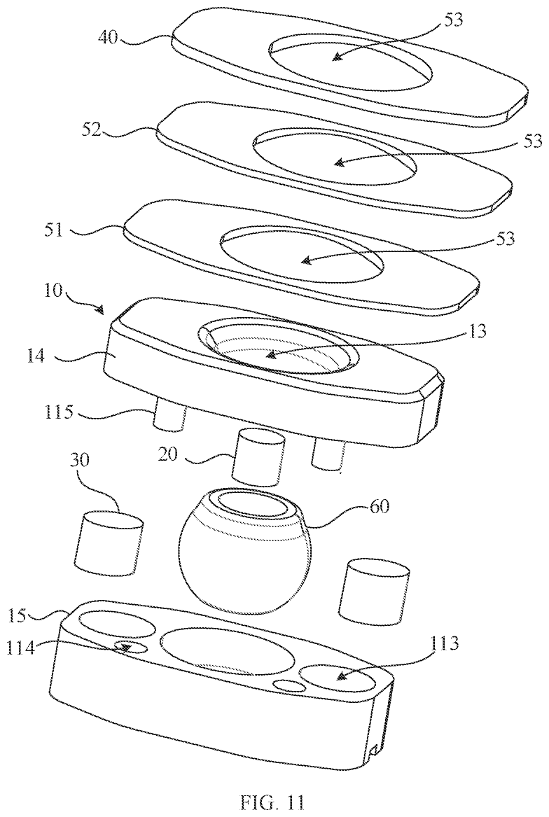

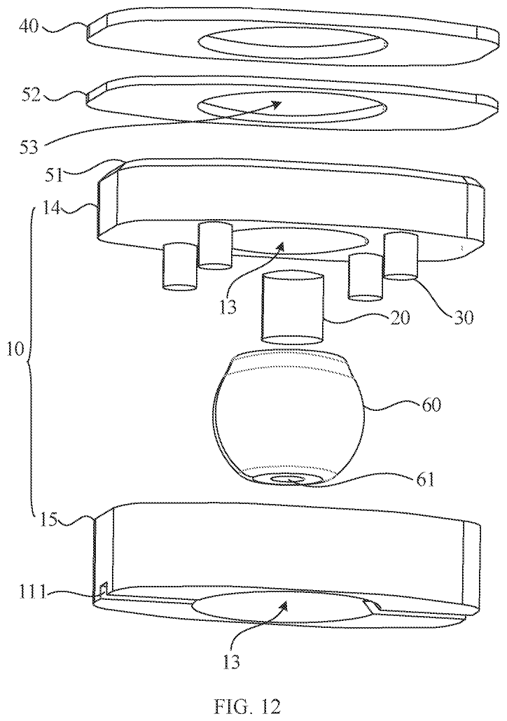

Optionally, the first connecting portion 30 can be provided separately from the mounting base 10. Referring to FIGS. 4 to 7, a side of the mounting base 10 away from the optical engine 20 is provided with a groove 113. The first connecting portion 30 is arranged in the groove 113. Then, the first protective layer 51 is arranged on the first connecting portion 30, for example, by bonding. The first connecting portion 30 may be an iron sheet or a magnet, or the like. In another embodiment, referring to FIG. 11, the groove 113 is arranged on the side of the mounting base 10 facing the optical engine 20. The first connecting portion 30 can be a magnet or an iron block located in the groove 113. For example, two first connecting portions 30 are arranged on both sides of the mounting base 10. As shown in FIG. 12, two or more first connecting portions 30 may be provided. For example, four first connecting portions 30 are arranged in the circumferential direction.

In some embodiments, the maximum diameter of the first connecting portion 30 and/or the second connecting portion 40 is less than or equal to 5 mm. The connecting portions 30, 40 with such small size can achieve lightweight adaptation and is not likely to have too much impact on the applied optical lens.

Referring to FIGS. 1 to 7, the display devices 1 may further include a sleeve 60. The optical engine 20 may be arranged in the sleeve 60. The sleeve 60 can encapsulate and protect the optical engine 20. The mounting base 10 is provided with a mounting groove 13. The sleeve 60 is arranged in the mounting groove 13 to adjust the light emission angle of the optical engine 20. The sleeve 60 can be shaped to match a shape of the optical engine 20. For example, the sleeve 60 can be a cylindrical sleeve, so that the optical engine 20 can emit light at a specific fixed angle. Optionally, the sleeve 60 may also have other shapes, such as a spherical shape. The display device 1 may further include an arc-shaped elastic piece 17. The arc-shaped elastic piece 17 is arranged in the mounting groove 13 and abuts against the sleeve 60. The arc-shaped elastic piece 17 can enable a tighter fit between the spherical mounting groove 13 and the spherical sleeve 60, thereby reducing the probability of the sleeve 60 shaking randomly. The sleeve 60 is provided with a first through hole 61 and a fitting groove 62. The first through hole 61 is in communication with the fitting groove. The optical engine 2 is arranged in the fitting groove. An end surface of the optical engine 2 is lower than an end surface of the fitting groove, so that the risk of friction damage to the optical engine 2 is reduced. The mounting base 10 is provided with a wiring hole 111 in communication with the mounting groove 13. The first through hole 61 is in communication with the wiring hole 111, and the electrical wiring of the optical engine 20 extends through the first through hole 61. It can be understood that the optical engine 20 can further be provided with electrical components (such as circuit boards or wire leads, etc.), which can be connected to an external power supply or a driving board to drive the optical engine 20. The wire leads of the optical engine 20 can pass through the first through hole 61, and then be leaded to the wiring hole 111, and then be connect the external power supply or wires, etc.

In some embodiments, referring to FIGS. 1 to 7, the mounting base 10 may include a base 11 and a spherical base 12 arranged on the base 11. The base 11 may be cylindrical, truncated or prism-shaped. The wiring hole 111 is arranged on the base 11. The mounting groove 13 is arranged on the spherical base 12. The mounting groove 13 is spherical. The spherical base 12 can be formed by a plurality of arc-shaped rings spaced around the base 11, which can have a certain amount of deformation when subjected to external forces. The sleeve 60 is a spherical sleeve. The spherical sleeve 60 can rotate in the spherical mounting groove 13 to adjust the light emission angle of the optical engine 20. When it is necessary to adjust the light emission angle of the optical engine 20, the rotation direction of the spherical sleeve 60 can be operated, for example, adjusted by fingers or special tools. In an embodiment, the display device 1 further includes an arc-shaped elastic piece 17. The arc-shaped elastic piece 17 is arranged in the mounting groove 13 and abuts against the sleeve 60. The arc-shaped elastic piece 17 can enable a tighter fit between the spherical mounting groove 13 and the spherical sleeve 60, thereby reducing the probability of the sleeve 60 shaking randomly. The spherical sleeve 60 is placed in the spherical mounting groove 13 and is limited by the spherical base 12. The first connecting portion 30 and the second connecting portion 40 are away from the light emission side of the optical engine 20. Such configuration can ensure that the optical engine 20 directly faces the human eye. As shown in FIG. 1, the entire mounting base 10 can be located on the side of the lens 2 facing the human eye. That is, the light from the optical engine 20 does not need to pass through the lens 2 to enter the human eye, that is, the optical engine 20 is built-in. This method allows the light from the optical engine 20 to directly enter the human eye without considering the light impact caused by the lens 2, for example, without considering the loss of the light from the optical engine.

In other embodiments, referring to FIGS. 4 to 7, the first connecting portion 30, the second connecting portion 40, and the sleeve 60 are coaxially arranged. The wiring hole 111 is exposed on a sidewall of the base 11, and an axial direction of the wiring hole 111 is perpendicular to a direction of a connecting line between the first connecting portion 30 and the second connecting portion 40. A wiring groove of the wiring hole 111 is shielded by the first connecting portion 30 and hidden inside the base 11. The first through hole 61 can be located at the center bottom of the sleeve 60, and can also be arranged coaxially with the base 11. The above-mentioned hidden wiring can make the overall appearance more aesthetics, and the coaxial arrangement may not affect angle adjustment of the spherical sleeve 60.

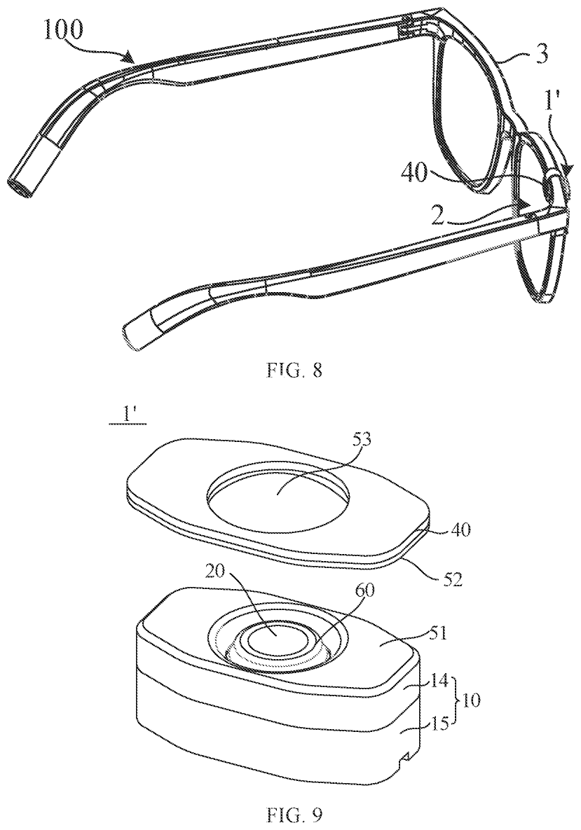

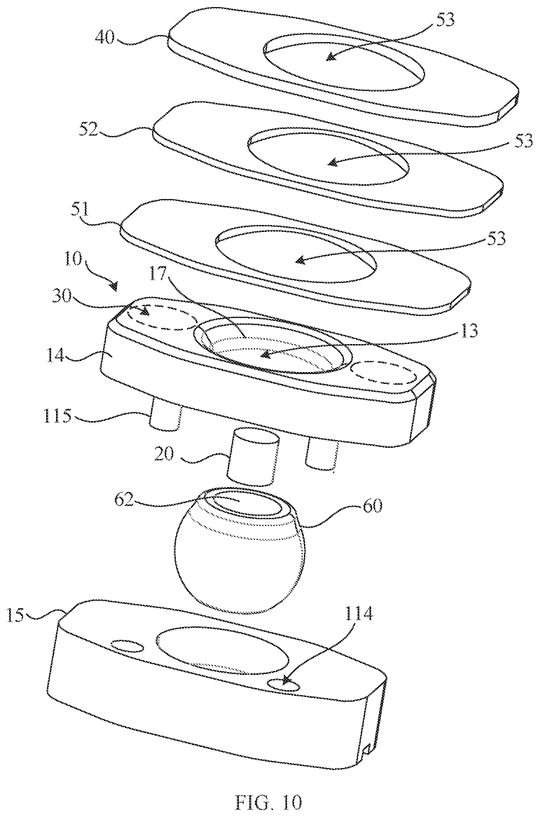

Referring to FIGS. 8 to 10, a display device l′ according to another embodiment is provided, which is similar to the display device 1, except that, the mounting base 10 includes a first assembling base 15 and a second assembling base 14 arranged on the first assembling base 15. The first assembling base 15 and the second assembling base 14 may be arranged in parallel. For example, the first assembling base 15 and the second assembling base 14 may be fixed by bonding or magnetic attraction. In some embodiments, the first assembling base 15 and the second assembling base 14 may be magnetically attached, which can facilitate the disassembly and assembly of the assembling bases, and is beneficial to the mounting and replacement of the optical engine 20. In addition, the magnetic attraction effect between the first assembling base 15 and the second assembling base 14 can be fully utilized, so that the first assembling base 15 and the second assembling base 14 can be further couple to the first connecting portion 30 and the second connecting portion 40 that are attracted to each other. In this way, the assembly of the entire display device 1′ is more flexible.

Continuing to refer to FIGS. 8 to 10, a positioning hole 114 and a positioning post 115 can also be arranged on the first assembling base 15 and the second assembling base 14, respectively. The positioning post 115 and the positioning hole 114 can play a mistake-proof and positioning role. In some embodiments, the positioning post 115 may also be a portion of the first connecting portion 30; the wiring hole 111 is arranged on the first assembling base 15, and the first assembling base 15 and the second assembling base 14 are coaxially provided with the mounting groove 13. The mounting groove 13 is spherical. The sleeve 60 is spherical. The spherical sleeve 60 can rotate in the spherical mounting groove to adjust the light emission direction of the optical engine 20. When it is necessary to adjust the light emission angle of the optical engine 20, the spherical sleeve 60 can be operated, for example, by fingers or special tools. The first connecting portion 30 and the second connecting portion 40 face the light emission side of the optical engine 20. The wiring hole 111 may be located on a side of the first assembling base 13 away from the optical engine 20.

In some embodiments, continuing to refer to FIGS. 8 to 10, the first protective layer 51, the second protective layer 52, and the second connecting portion 40 are provided with light holes 53, respectively. Sizes of the light holes 53 may be greater than the size of the optical engine 20. The light hole 53 ensures that the light from the optical engine 20 can reach the human eye. It can be understood that the entire mounting base 10 can be located on the side of the lens 2 away from the human eye, and the first connecting portion 30 and the second connecting portion 40 can be spaced apart on two sides of the light hole 53. That is, the light from the optical engine 20 firstly passes through the lens 2 and then enters the human eye, that is, the optical engine 20 is externally arranged. This method (compared to the built-in arrangement of the optical engine 20) can reduce discomfort of the human eye caused by the overall mounting base 10 directly protruding from the lens 2, such as psychological discomfort, etc.

In some embodiments, referring to FIGS. 10 to 12, the first assembling base 15 and the second assembling base 14 may be square or elliptical in shape. The sidewall of the spherical mounting groove 13 formed by the first assembling base 15 and the second assembling base 14 has a height greater than the radius of the spherical sleeve 60. The spherical shape here can be interpreted as a spherical sidewall portion where the spherical mounting groove 13 is in direct contact with the spherical sleeve 60. Other portions of the spherical sleeve 60 (for example, the portion not in contact with the mounting groove 13) may be of other aspherical shapes. For example, a portion of the sleeve 60 close to the end surface may be trumpet-shaped or cylindrical, etc. In other embodiments, for the convenience of manufacturing, the sleeve 60 may also have an overall standard spherical shape. It is ensured that the height of the portion of the inner wall of the mounting groove 13 in contract with the spherical sleeve 60 is at least greater than the center height of the spherical sleeve, and ensured that the first assembling base 15 and the second assembling base 14 are pressed to each other in an up-down direction, to limit the sleeve 60 from falling. In an embodiment, the display device l′ further includes an arc-shaped elastic piece 17. The arc-shaped elastic piece 17 is arranged in the mounting groove 13 and abuts against the sleeve 60. The arc-shaped elastic piece 17 can enable a tighter fit between the spherical mounting groove 13 and the spherical sleeve 60, thereby reducing the probability of reduces the probability of the sleeve 60 shaking randomly.

In some embodiments, referring to FIGS. 1 and 8, the lens 2 may be connected to a frame 3. The lens 2 is arranged on the frame 3. The connecting member 50 spans the frame 3 and is located on opposite sides of the lens 2. The connecting member 50 located on both sides of the lens 2 may be designed in a generally symmetrical manner to ensure that the first connecting portion 30 and the second connecting portion 40 are centrally aligned.

In the display device according to the embodiments of the present disclosure, the optical engine is mounted on the mounting base; the first connecting portion is arranged on the mounting base; and the first connecting portion and the second connecting portion are arranged opposite to each other, and are configured to clamp the lens and allow the mounting base to move on the lens, so that the position of the optical engine relative to the lens can be adjusted, thereby enabling flexible changes in multiple positions to adapt to the interpupillary distances, field of view angles, etc. of different users, and to meet the viewing needs and preferences of different users.

In another embodiment, the present disclosure further provides a wearable device 100, as shown in FIGS. 1 and 8. The wearable device 100 includes a lens 2, a frame 3, and a display device 1 or 1′. The lens 2 is arranged on the frame 3. The display device 1 or 1′ is arranged on the lens 2. The wearable device 100 can be adapted to the interpupillary distances, field of view angles, etc. of different users, and to meet the viewing needs and preferences of different users.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

Although the present disclosure is illustrated and described herein with reference to specific embodiments, the present disclosure is not intended to be limited to the details shown. Rather, various modifications may be made in the details within the scope and range of equivalents of the claims and without departing from the present disclosure.

What is claimed is:

1. A display device applied to a lens, the display device comprising:
a mounting base;
an optical engine mounted on the mounting base;
a first connecting portion arranged on the mounting base and configured to be connected to a first side of the lens; and
a second connecting portion arranged opposite to the first connecting portion and configured to be connected to a second side of the lens, the first side and the second side of the lens being opposing sides;
wherein the first connecting portion and the second connecting portion are configured to clamp the lens and allow the mounting base to move on the lens, so as to adjust a position of the optical engine relative to the lens.

2. The display device according to claim 1, further comprising a first protective layer and a second protective layer;
wherein the first protective layer is connected to the first connecting portion and faces the second connecting portion, and the second protective layer is connected to the second connecting portion and faces the first connecting portion;
wherein the first protective layer and the second protective layer are configured to be in contact with the lens and prevent the lens from being damaged when the first connecting portion and the second connecting portion move relative to the lens.

3. The display device according to claim 1, further comprising a connecting member;
wherein an end of the connecting member is connected to at least one of the first connecting portion and the first protective layer, and another end of the connecting member is connected to at least one of the second connecting portion and the second protective layer; and the connecting member is configured to span the lens.

4. The display device according to claim 1, wherein the first connecting portion and the mounting base are integrally formed; or the first connecting portion and the mounting base are separately formed.

5. The display device according to claim 1, wherein the first connecting portion and the second connecting portion are made of magnetic materials that are attracted to each other.

6. The display device according to claim 1, wherein a maximum diameter of the first connecting portion or the second connecting portion is less than or equal to 5 mm.

7. The display device according to claim 1, further comprising a sleeve;
wherein the optical engine is arranged in the sleeve; the mounting base is provided with a mounting groove; the sleeve is arranged in the mounting groove to adjust a light emission angle of the optical engine.

8. The display device according to claim 7, wherein the sleeve is provided with a first through hole and a fitting groove; the optical engine is arranged in the fitting groove; the mounting base is provided with a wiring hole in communication with the mounting groove; and the first through hole is in communication with the wiring hole, an electrical wiring of the optical engine extends through the first through hole.

9. The display device according to claim 8, wherein the mounting base comprises a base and a spherical base arranged on the base; the wiring hole is arranged on the base; the mounting groove is provided on the spherical base; the mounting groove is spherical; the sleeve is spherical; the sleeve is capable of rotating in the mounting groove to adjust the light emission angle of the optical engine; and the first connecting portion and the second connecting portion are away from a light emission side of the optical engine.

10. The display device according to claim 9, wherein the first connecting portion, the second connecting portion, and the sleeve are coaxially arranged; the wiring hole is exposed on a sidewall of the base; an axial direction of the wiring hole is perpendicular to a direction of a connecting line between the first connecting portion to the second connecting portion.

11. The display device according to claim 7, wherein the mounting base comprises a first assembling base and a second assembling base arranged on the first assembling base;
wherein the wiring hole is arranged on the first assembling base; the first assembling base and the second assembling base are coaxially provided with the mounting groove; the mounting groove is spherical; the sleeve is spherical; the spherical sleeve is capable of rotating in the mounting groove to adjust a light emission direction of the optical engine; and the first connecting portion and the second connecting portion face a light emission side of the optical engine.

12. The display device according to claim 11, wherein a sidewall of the mounting groove formed by the first assembling base and the second assembling base has a height greater than a radius of the sleeve.

13. The display device according to claim 2, wherein the first protective layer, the second protective layer, and the second connecting portion are provided with light emission holes respectively.

14. The display device according to claim 7, further comprising an arc-shaped elastic piece arranged in the mounting groove and abutting against the sleeve.

15. The display device according to claim 3, wherein the lens is arranged on a frame; the connecting member spans the frame and is located on opposite sides of the lens.

16. The display device according to claim 3, wherein the connecting member is wrapped around the first connecting portion or the second connecting portion.

17. The display device according to claim 3, wherein the connecting member, the first protective layer, and the second protective layer are integrally formed.

18. The display device according to claim 3, wherein the connecting member is capable of adjusting moving distances of the first connecting portion and the second connecting portion; and the moving distances of the first connecting portion and the second connecting portion on the lens is within approximately half a length of the connecting member.

19. The display device according to claim 1, wherein a side of the mounting base away from the optical engine is provided with a groove; and the first connecting portion is arranged in the groove.

20. A wearable device, comprising:
a lens;
a frame on which the lens is arranged; and
the display device according to claim 1,
wherein the display device is arranged on the lens.
